(19) United States
(12) Patent Application Publication
(10) Pub. No.: US 2025/0220698 A1
(43) Pub. Date: Jul. 3, 2025

(54) METHOD TO IMPROVE SINR OF THE 5G NR SSB USING TIME SHIFTING

(71) Applicant: Mavenir Systems, Inc., Richardson, TX (US)

(72) Inventors: Rangsan Leelahakriengkrai, Allen, TX (US); Ramesh Chandran, Bangalore (IN); Charles Santhosam Lourdu Raja, Bangalore (IN); Yang Tian, Beijing (CN)

(73) Assignee: Mavenir Systems, Inc., Richardson, TX (US)

(21) Appl. No.: 19/084,475

(22) Filed: Mar. 19, 2025

Related U.S. Application Data
(63) Continuation of application No. PCT/CN2022/120565, filed on Sep. 22, 2022.

(51) Int. Cl. H04W 72/542; H04W 72/1268; H04W 72/231

(52) U.S. Cl. CPC H04W 72/542; H04W 72/1268; H04W 72/231

(57) ABSTRACT

A system for optimizing signal to interference plus noise ratio (SINR) of a 5G New Radio (NR) network including multiple cell sites each having at least one sector, and at least one of the cell sites in communication with a user equipment (UE), the system includes: a radio resource controller (RRC) configured to control a combination synchronization signal and physical broadcast channel block (SSB) locations for all sectors of the cell sites; and a medium access control (MAC) scheduler configured to schedule SSB in each sector in at least one of frequency and time; wherein the RRC configures SSB indices for all sectors of the cell sites so that no two immediately adjacent sectors share the same SSB index.

### CROSS REFERENCE TO RELATED APPLICATIONS

The present application is a continuation application of International (PCT) application No. PCT/CN2022/120565 filed on Sep. 22, 2022 and is incorporated herein by reference in entirety.

### BACKGROUND OF THE DISCLOSURE

### 1. Field of the Disclosure

The present disclosure relates to systems and methods for 5G New Radio (NR), and relates more particularly to systems and methods to improve Signal to Interference Plus Noise Ratio (SINR) of the combination Synchronization Signal (SS)/Physical Broadcast Channel (PBCH) Block (which combination is referenced by the acronym SSB) in the 5G NR cellular systems.

### 2. Description of the Related Art

SSBs are used by the user equipment (UE) during, e.g., the following situations: i) a cell search procedure to find a cell to camp on, and ii) during handover to find suitable target cells. SSB occupies 20 resource blocks (RBs) and 4 symbols in a cell. In a typical configuration, all cells have SSB in the same RB location and in slot 0, 20, 40, etc. (i.e., SSB is repeating every 20 ms by default). This configuration is shown in FIG. 1, which illustrates a typical SSB location where SSB is, i.e., on the same frequency and time slot for all cells. In FIG. 1, three sectors of an example cell are illustrated, e.g., Sector Alpha 101, Sector Beta 102, and Sector Gamma 103. It should be noted that the number of sectors shown is merely exemplary, and the number of sectors can vary (e.g., 1, 2, 3 or 4).

This use of the same frequency and time slot for all cells creates interference among SSBs of different cells, as illustrated in FIG. 2. In the example shown in FIG. 2, each cell site (e.g., 201, 202, and 203) is associated with three sectors (e.g., 201 is associated with 201a, 201b and 201c; 202 is associated with 202a, 202b, and 202c; and 203 is associated with 203a, 203b, and 203c). UE 10 is receiving signal in the sector 201b, but there is interference from SSBs of sectors 203a (of cell 203) and 202c (of cell 202).

The UE can detect a PBCH when SS-SINR is at least −10.9 dB (e.g., as per 3GPP TS38.101-4 Release 15), so this is the minimum level of SS-SINR needed to start Random access channel (RACH) procedure. However, from the field drive testing, it has been shown that SS-SINR needs to be at least −2 dB for other subsequent signals to be decoded. A field drive test has shown the probability of SS-SINR <−10 dB is 2.09%, i.e., the accessibility (no RACH=no access) can be at most 100−2.09=97.91% from these field drive test sites (actual RACH success rate achieved was 97.37%). To achieve 99.99% accessibility, the SS-SINR needs to be increased so that probability of SS-SINR <−10 dB will be 0.01% or less.

The above-mentioned issue cannot be solved by positioning the SSBs in different RBs in different sectors of the same cell site so that SSBs do not interfere with each other. In this configuration, SSB in one sector is still subject to interference by physical downlink shared channel (PDSCH) from other sectors. Moreover, this configuration requires that all handovers (HOs) to SSBs in different RBs are considered inter-frequency HOs even though all cells are in the same carrier. Therefore, this configuration complicates network operation, as it requires defining new frequencies in NR Neighbor Relation Table (NRT) in every cell.

Therefore, there is a need for an improved method and a system for improving the SINR of the SSB in the 5G NR systems.

### SUMMARY OF THE DISCLOSURE

According to an example method, a cellular communication system comprising a group of cell sites (e.g., each cell site having 1, 2, 3 or 4 sectors) communicates with at least one UE; a Radio Resource Controller (RRC) in CU-CP controls the SSB locations for the sectors in all sites; and a MAC Scheduler in each sector schedules SSB and PDSCH in frequency and time.

According to an example method, RRC configures different SSB indices to each sector.

According to an example method, Medium Access Control (MAC) Scheduler does not schedule any PDSCH on the same PRB and symbols as the SSB that would cause interference to SSB in other sectors.

According to an example method, in the case of a 3-sector site layout, RRC configures SSB indices 0, 1 and 3 to sectors Alpha, Beta and Gamma, respectively, of each site. This allows the usage of 3 OFDM symbols in Physical Downlink Control Channel (PDCCH) in sector Gamma.

According to an example method, RRC utilizes Physical Cell ID (PCI) modulo 3 operation to automatically configure each sector such that the sector with PCI mod 3=0, 1, 2 is configured with SSB index 0, 1 and 3, respectively.

According to an example embodiment of the present disclosure, a method is disclosed in which SBB Time Shifting or SSB time-domain positioning is implemented, e.g., compliant with 3GPP TS 32.213 section 4.1 for Case A-15 kHz SCS.

According to an example method of the present disclosure, the first symbols of the candidate SS/PBCH blocks have indexes of {2,8}+14·n with configurable n for carrier frequencies smaller than or equal to 3 GHz and n=0,1. This allows configuring SSB starting OFDM symbols to 2, 8, 16 or 22 (where 16 and 22 are symbol 2 and 8 in the next slot), which are designated as SSB index 0, 1, 2 and 3, respectively. SSB is transmitted in 4 OFDM symbols in time domain.

### BRIEF DESCRIPTION OF THE FIGURES

FIG. 1 illustrates a typical SSB location where SSB is on the same frequency and time slot for all cells.

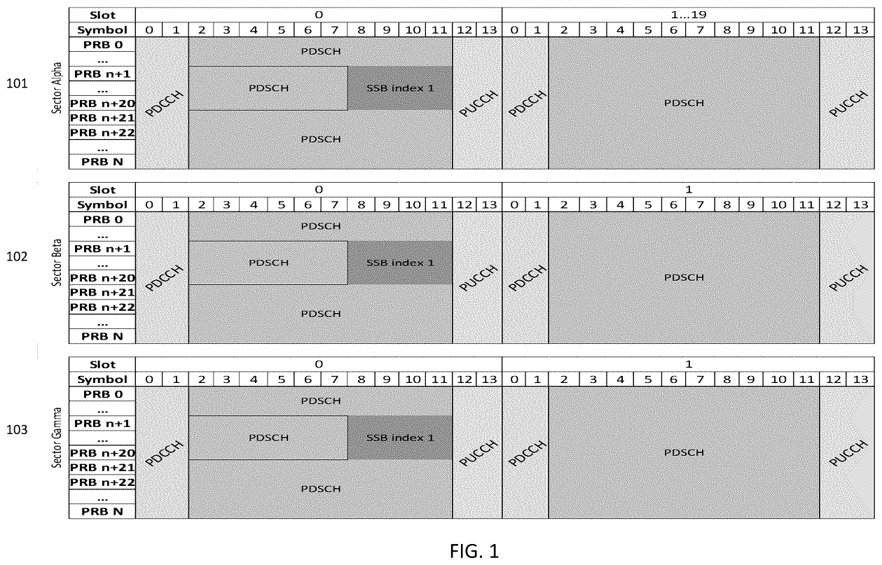

FIG. 2 illustrates an example of the use of the same frequency and time slot for all cells creating interference among SSBs of different cells.

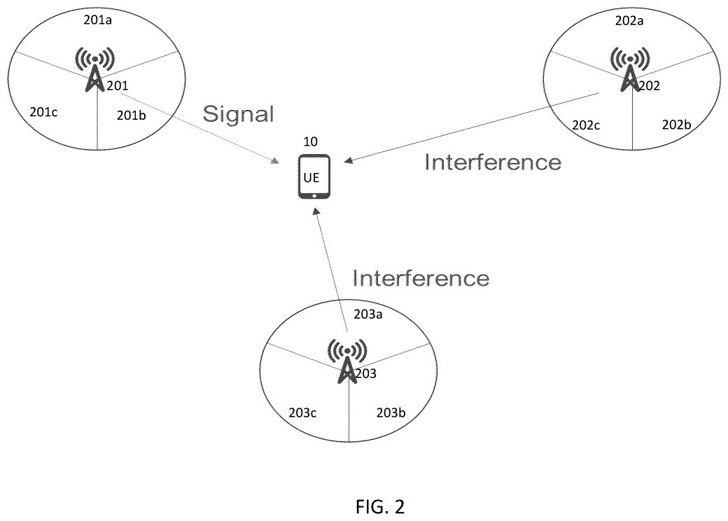

FIG. 3 illustrates components of an example wireless communication system.

FIG. 4 illustrates an example SSB time shifting method which configures SSB index 0, 1 and 3 to sectors Alpha, Beta and Gamma, respectively.

FIG. 5 illustrates an example SSB time shifting method, whereby sector Gamma of site 2 and sector Alpha of site 3 do not interfere with SSB signal from sector Beta of site 1.

FIG. 6 illustrates an example SSB time shifting method in which 2 OFDM symbols are configured for PDCCH in slots 0, 10, 20, . . . , and 3 OFDM symbols are configured for PDCCH in other slots.

FIG. 7 illustrates an example application of SSB time shifting method to omni-directional sites where no adjacent site uses the same SSB index.

FIG. 8 illustrates an example SSB time shifting method in which 4 SSB indices are used in an omni-directional site layout.

FIG. 9 illustrates an example SSB time shifting method applied to 2-sector site layout.

FIG. 10 illustrates an example SSB time shifting method applied to 4-sector site layout.

### DETAILED DESCRIPTION

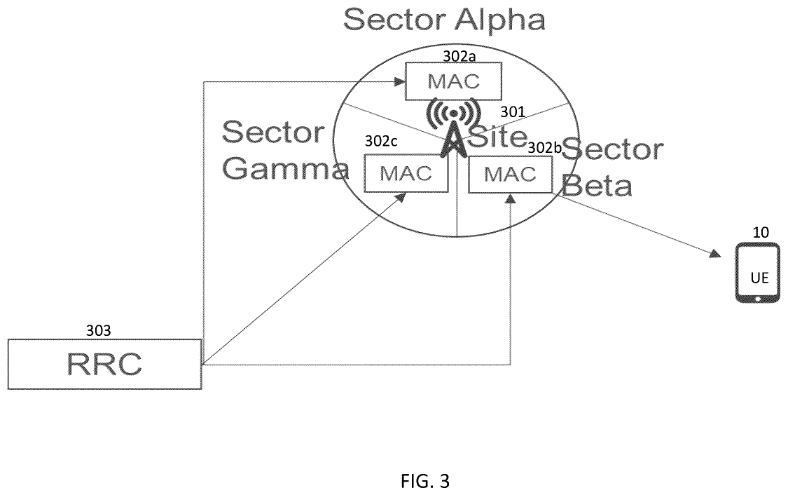

FIG. 3 illustrates components of an example wireless communication system in which an example cell site 301 has three sectors, i.e., Sector Alpha, Sector Beta, and Sector Gamma. The number of sectors is merely exemplary, and the number of sectors could be 1, 2, 3 or 4, for example. Although not explicitly shown, the wireless communication system is assumed to include multiple cell sites, and multiple UEs are assumed to be communicating with the cell sites (only one cell site and one UE is shown for the sake of clarity). A MAC Scheduler is provided in each sector of the cell site 301 (MAC scheduler 302a in Sector Alpha; MAC Scheduler 302b in Sector Beta; and MAC Scheduler 302c in Sector Gamma), which MAC Schedulers are responsible for scheduling SSB and PDSCH in frequency and time. In addition, a Radio Resource Controller (RRC) 303 is provided in CU-CP to control the SSB locations for the sectors in all cell sites.

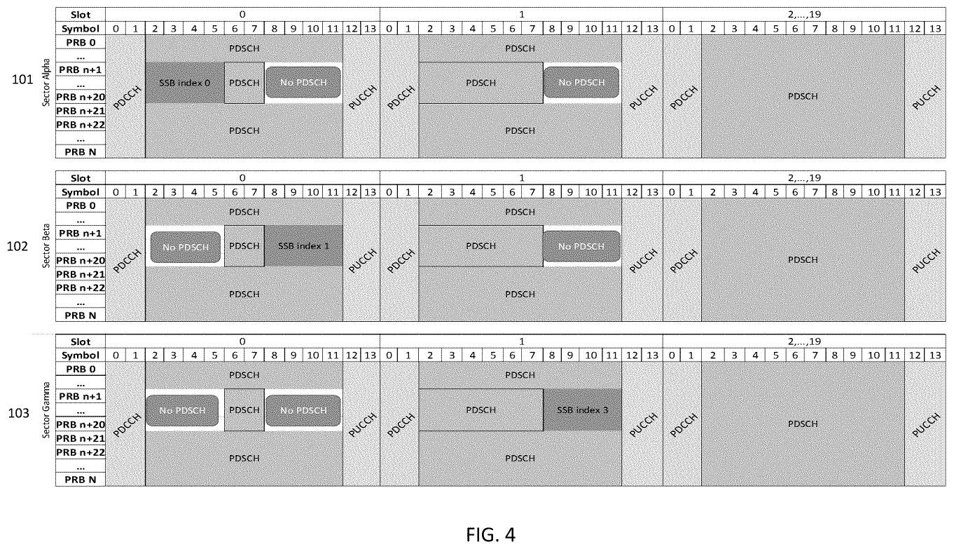

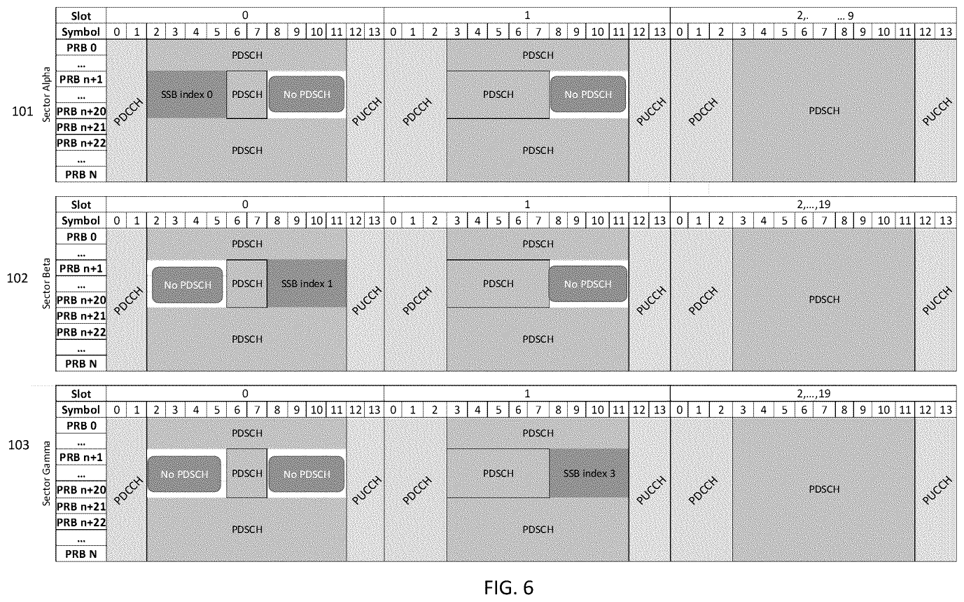

According to an example embodiment of the present disclosure, a method is disclosed in which SBB Time Shifting or SSB time-domain positioning is implemented, e.g., compliant with 3GPP TS 32.213 section 4.1 for Case A-15 kHz subcarrier spacing (SCS). According to this example method, the first symbols of the candidate SS/PBCH blocks have indexes of {2,8}+14·n with configurable n for carrier frequencies smaller than or equal to 3 GHz and n=0,1. This allows configuring SSB starting OFDM symbols to 2, 8, 16 or 22 (where 16 and 22 are symbols 2 and 8 in the next slot), which are designated as SSB index 0, 1, 2 and 3, respectively. SSB is transmitted in 4 OFDM symbols in time domain. As shown in FIG. 4, this example method configures SSB indices 0, 1, and 3 to sectors Alpha 101, Beta 102 and Gamma 103, respectively. This configuration allows the usage of 3 OFDM symbols in PDCCH, e.g., in sector Gamma 103, as will be explained in more detail in connection with FIG. 6. The configuration is performed by Radio Resource Controller (RRC) located in CU-CP in 5G NR or O-RAN architecture.

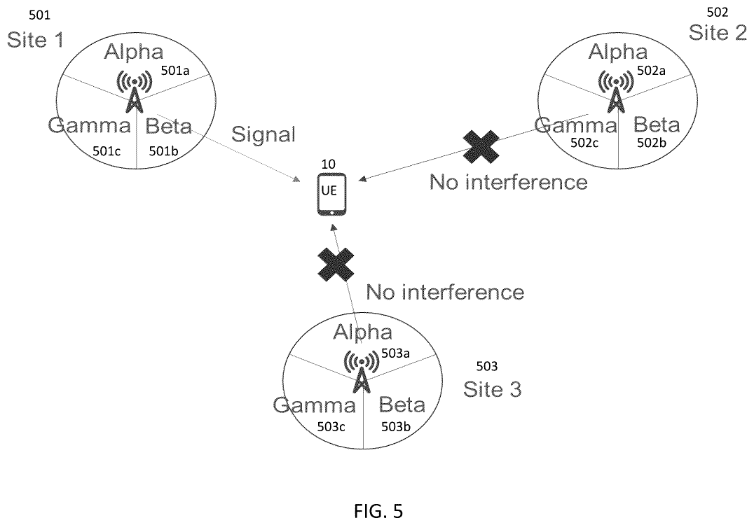

As shown in FIG. 4, the MAC Scheduler does not schedule a PDSCH on the same RB and symbols that would cause interference to SSB in other sectors. For example, for SSB index 0 assigned to Sector Alpha 101, no PDSCH is scheduled for Sector Beta 102 and Sector Gamma 103. Similarly, for SSB index 3 assigned to Sector Gamma 103, no PDSCH is scheduled for Sector Alpha 101 and Sector Beta 102. In this manner, each sector creates no interference to SSB in other sectors. FIG. 5 provides an illustration of this elimination of interreference in a typical 3-sector site configuration. In the example shown in FIG. 5, each cell site (e.g., 501, 502, and 503) is associated with three sectors (e.g., 501 is associated with 501a, 501b and 501c; 502 is associated with 502a, 502b, and 502c; and 503 is associated with 503a, 503b, and 503c). UE 10 is receiving signal in the sector 501b, and there is no interference from SSBs of sectors 503a (of cell site 503) and 502c (of cell site 502) due to the above-described scheduling, i.e., not scheduling a PDSCH on the same RB and symbols that would cause interference to SSB in other sectors.

To help with operation and deployment, the configuration of sectors can be done automatically by using PCI % 3 (where % is modulo operation). That is, if PCI % 3=0, then configure SSB index 0 and so on. This would reduce the operational and deployment complexity. A summary table for this operation is shown below:

| | |
|---|---|
| If PCI % 3 = 0 | Then Configure SSB with SSB Index 0 |
| If PCI % 3 = 1 | Then Configure SSB with SSB Index 1 |
| If PCI % 3 = 2 | Then Configure SSB with SSB Index 3 |

For a carrier with 5 MHz bandwidth, 3 OFDM symbols for PDCCH is preferred to increase the PDCCH capacity. According to an example method of the present disclosure, 2 OFDM symbols can be configured for PDCCH in slot 0 and repeating per predetermined SSB periodicity (e.g., slots 0, 10, 20, etc.), and 3 OFDM symbols can be configured for PDCCH in other slots. This can be achieved because SSB index 3 is chosen in sector Gamma. FIG. 6 illustrates the above-described OFDM symbols configuration for this example method. For the PDCCH in slot 0, 2 OFDM symbols are configured, and the 3 OFDM symbols are configured for PDCCH in slots 1 through 9.This pattern is repeated starting at slot 10.

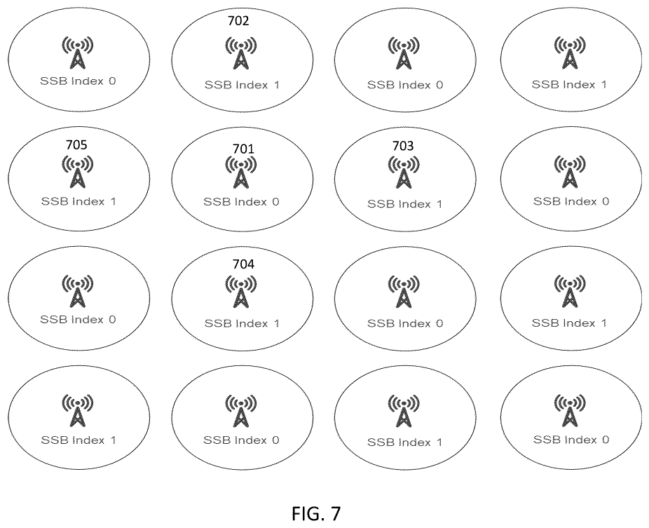

The example method according to the present disclosure can be extended to 1-sector (or omni-directional) cell sites, including some indoor deployment scenarios. In the case of omni-directional cell sites, if the carrier has bandwidth more than 5 MHz and 2-symbol PDCCH is chosen, an example method utilizes SSB indices 0 and 1 (symbols 2 and 8 in slot 0). In this case, MAC Scheduler does not need to avoid scheduling PDSCH in slot 1, thereby increasing peak DL throughput. According to an example embodiment, the CU-CP can configure the omni-directional cell sites such that, for any given cell site, immediately adjacent cell sites have a different SSB index than the given cell site, one example layout of which configuration is illustrated in FIG. 7. For example, cell site 701 having SSB index 0 is immediately adjacent to cell sites 702, 703, 704 and 705 each having SSB index 1. The layout shown in FIG. 7 is merely an example, and other layouts can be implemented.

According to another example embodiment of the present disclosure, in the case the carrier has bandwidth of 5 MHz and 3-symbol PDCCH is chosen, only SSB indices 1 and 3 (symbol 8 in both slot 0 and slot 1) are used. As in the configuration of FIG. 7, the CU-CP can configure the omni-directional cell sites such that, for any given cell site, immediately adjacent cell sites have a different SSB index than the given cell site. In the example embodiment using indices 1 and 3, the configuration shown in FIG. 7 would be altered by i) replacing SSB index 0 with 1, and ii) replacing SSB index 1 with 3.

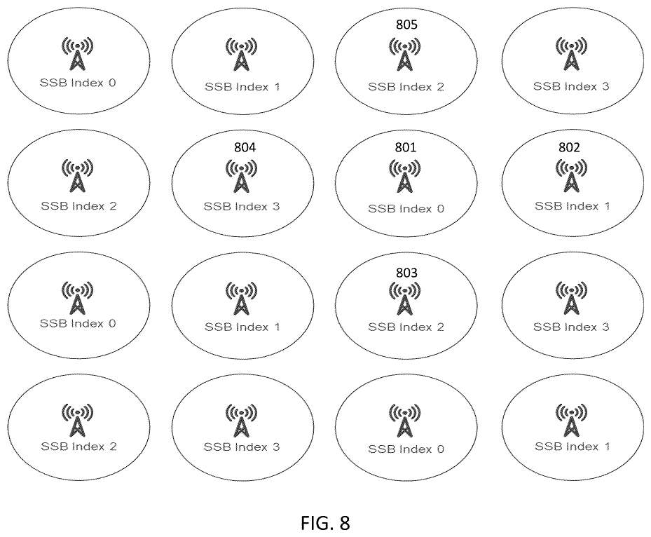

According to another example embodiment of the present disclosure, all 4 SSB indices can be used. This configuration enables further reduction in interferences if the signals from adjacent sites are high. One example layout of a configuration using all 4 SSB indices is illustrated in FIG. 8. As shown in FIG. 8, cell site 801 with SSB index 0 is immediately adjacent to cell sites 802 (with SSB index 1), 803 (with SSB index 2), 804 (with SSB index 3), and 805 (with SSB index 2). This pattern is true for each cell site, i.e., for any given cell site, immediately adjacent cell sites have a different SSB index than the given cell site.

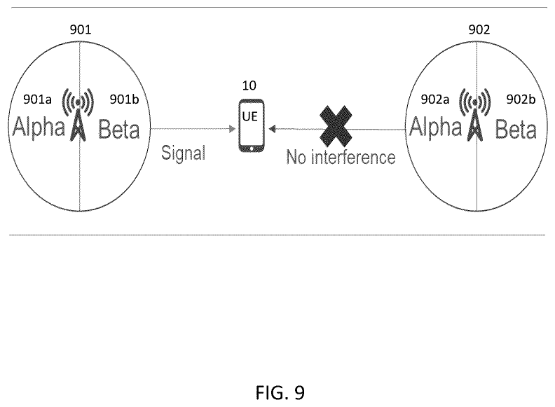

According to an example method of the present disclosure, the technique of using different SSB indices in adjacent cell sites can be applied to 2-sector cell sites. Some of the deployment scenarios include uses on a highway or in a tunnel where 2 sectors covering both sides of the road in a straight line. An example implementation of this deployment is illustrated in FIG. 9, in which the UE 10 is serviced by the beta sector 901b of the cell site 901, and cell site 902 (with sectors Alpha 902a and Beta 902b) is adjacent to the cell site 901. In this configuration, no interference is experienced from the alpha sector 902a of the cell site 902 because sectors 901b and 902a have different SSB indices. According to an example method, SSB indices 0 (symbol 2 in slot 0) and 1 can be configured for sectors Alpha and Beta, respectively. This configuration is suitable for carriers with bandwidth more than 5 MHz or in the case 2-symbol PDCCH is chosen. This allows only slot 0 to be occupied by the SSB of sector Alpha, and MAC Scheduler does not need to avoid scheduling in slot 1, hence, allowing higher peak DL throughput. According to another example method, SSB indices 1 and 3 (symbol 8 in both slots 0 and 1) can be configured for sectors Alpha and Beta, respectively. This configuration is suitable for carriers with 5 MHz bandwidth and in the case 3-symbol PDCCH is chosen.

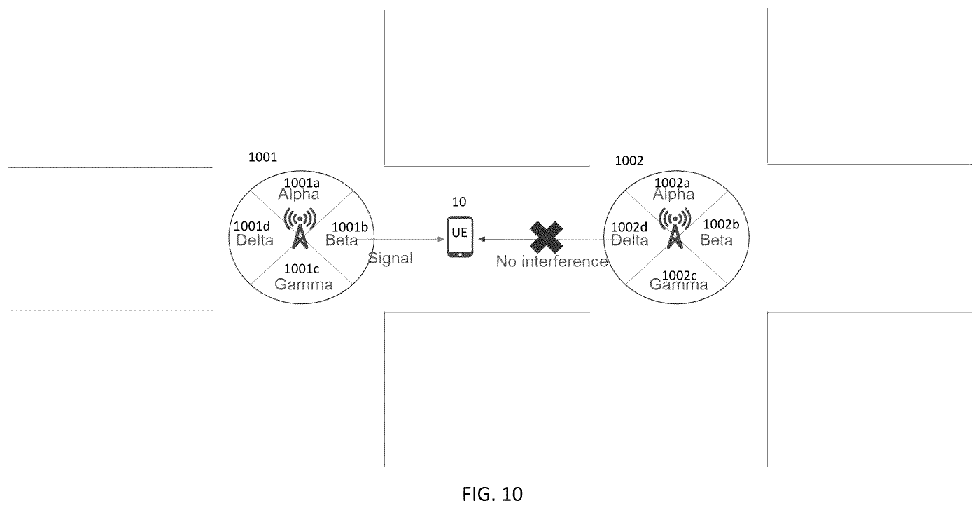

According to yet another example method of the present disclosure, the technique of using different SSB indices in adjacent cell sites can be applied to 4-sector sites. Some of the deployment scenarios include uses on intersections in cities with tall buildings which often create a canyon effect. An example implementation of this deployment is illustrated in FIG. 10, in which each sector covers each side of the street, i.e., SSB indices 0, 1, 2, and 3 are configured for sectors Alpha, Beta, Gamma and Delta, respectively. As shown in FIG. 10, UE 10 is located between cell site 1001 (with sectors Alpha 1001a, Beta 1001b, Gamma 1001c and Delta 1001d) and cell site 1002 (with sectors Alpha 1002a, Beta 1002b, Gamma 1002c and Delta 1002d). In this example, UE 10 is serviced by sector Beta 1001b of cell site 1001, but no interference is experienced from sector Delta 1002d of cell site 1002 because of the use of different SSB indices for the opposing sectors 1001b and 1002d.

In summary, several example embodiments of methods and system are disclosed herein to improve SINR of 5G NR SSB by using time shifting.

According to an example embodiment, a cellular communication system comprising a group of cell sites (e.g., each cell site having 1, 2, 3 or 4 sectors) communicates with at least one UE; a Radio Resource Controller (RRC) in CU-CP controls the SSB locations for the sectors in all sites; and a MAC Scheduler in each sector schedules SSB and PDSCH in frequency and/or time.

According to an example embodiment, RRC configures different SSB indices to each sector.

According to an example embodiment, MAC Scheduler does not schedule PDSCH on the same resource block (RB) and/or symbols that would cause interference to SSB in other sectors.

According to an example embodiment, in the case of a 3-sector site layout, RRC configures SSB indices 0, 1 and 3 to sectors Alpha, Beta and Gamma, respectively, of each site.

According to an example embodiment, RRC utilizes Physical Cell ID (PCI) modulo 3 operation to automatically configure each sector such that the sector with PCI mod 3=0, 1, 2 is configured with SSB index 0, 1 and 3, respectively.

According to an example embodiment, for a carrier with 5 MHz bandwidth, RRC configures 2 OFDM symbols for PDCCH in slots 0, 10, 20, . . .(repeating per SSB periodicity, if different from default) and configures 3 OFDM symbols for PDCCH in other slots.

According to an example embodiment, in the case of 1-sector or omni-directional site layout and the carrier has bandwidth of more than 5 MHz or 2-symbol PDCCH is chosen, RRC configures different SSB indices 0 and 1 to adjacent sites such that, for a given site, no immediately adjacent site has the same SSB index as the given site.

According to an example method, in the case of 1-sector or omni-directional site layout and the carrier has bandwidth 5 MHz and 3-symbol PDCCH is chosen, RRC configures different SSB indices 1 and 3 to adjacent sites such that, for a given site, no immediately adjacent site has the same SSB index as the given site.

According to an example embodiment, in the case of 1-sector or omni-directional site layout and the carrier has bandwidth more than 5 MHz and 2-symbol PDCCH is chosen, RRC configures different SSB indices to immediately adjacent sites such that no two adjacent sites have the same SSB index.

According to an example embodiment, in the case of 2-sector site layout and the carrier has bandwidth more than 5 MHz or 2-symbol PDCCH is chosen, RRC configures different SSB indices 0 and 1 to sectors Alpha and Beta, respectively, of each site.

According to an example embodiment, in the case of 2-sector site layout and the carrier has bandwidth is 5 MHz and 3-symbol PDCCH is chosen, RRC configures different SSB indices 1 and 3 to sectors Alpha and Beta, respectively, of each site.

According to an example embodiment, in the case of 4-sector site layout, RRC configures SSB indices 0, 1, 2, and 3 to sectors Alpha, Beta, Gamma and Delta, respectively, of each site.

### DEFINITIONS

3GPP: 3rd Generation Partnership Project
BS: Base Station
CCH: Control channel
CUS-plane: Control, user, and synchronization plane
DL: Downlink
eNB: eNodeB (4G LTE base station)
gNB: gNodeB (5G NR base station)
M-plane: Management plane
MAC: Medium Access Control
NR: new radio interface and radio access technology for cellular networks
PDCCH: Physical Downlink Control Channel
PDSCH: physical downlink shared channel
PRACH: Physical random-access channel
PRB: Physical resource block
RRC: Radio Resource Controller
RIC: RAN Intelligent Controller
RACH: Random access channel
RE: Resource element
SS: Synchronization Signal
SSB: combination Synchronization Signal (SS)/Physical Broadcast Channel (PBCH) Block
SNR: Signal to Noise Ratio
SINR: Signal to Interference Plus Noise Ratio
TCH: Traffic channel
UL: Uplink
UE: User Equipment
PBCH: Physical Broadcast Channel
DMRS: Demodulation Reference Signal
OFDM: Orthogonal Frequency Division Multiplexing

What is claimed is:

1. A system for optimizing signal to interference plus noise ratio (SINR) of a 5G New Radio (NR) network including multiple cell sites each having at least one sector, and at least one of the cell sites in communication with a user equipment (UE), the system comprising:
a radio resource controller (RRC) configured to control a combination synchronization signal and physical broadcast channel block (SSB) locations for all sectors of the cell sites; and
a medium access control (MAC) scheduler configured to schedule SSB in each sector in at least one of frequency and time;
wherein the RRC configures SSB indices for all sectors of the cell sites so that no two immediately adjacent sectors share the same SSB index.

2. The system according to claim 1, wherein:
the MAC scheduler is configured to selectively schedule physical downlink shared channel (PDSCH) in each sector in at least one of frequency and time, and
for an SSB index in a given resource block (RB) and a given symbol location for a given sector, the MAC scheduler does not schedule PDSCH for other sectors in the given RB and the given symbol location of the SSB index for the given sector.

3. The system according to claim 1, wherein:
in the case each cell site has 3 sectors, the RRC configures SSB indices 0, 1 and 3 to a first sector Alpha, a second sector Beta, and a third sector Gamma, respectively, of each cell site.

4. The system according to claim 1, wherein:
the RRC utilizes Physical Cell ID (PCI) modulo 3 (mod 3) operation to automatically configure each sector whereby i) each sector with PCI mod 3=0 is configured with SSB index 0, ii) each sector with PCI mod 3=1 is configured with SSB index 1; and iii) each sector with PCI mod 3=2 is configured with SSB index 3.

5. The system according to claim 1, wherein:
in the case of a network carrier with 5 MHz bandwidth, RRC configures 2 Orthogonal Frequency Division Multiplexing (OFDM) symbols for Physical Downlink Control Channel (PDCCH) in every ten slots starting at slot 0, and configures 3 OFDM symbols for PDCCH in other slots.

6. The system according to claim 1, wherein:
in the case of one of 1-sector or omni-directional cell sites, the RRC configures different SSB indices to the cell sites such that no two immediately adjacent cell sites have the same SSB index.

7. The system according to claim 6, wherein at least one of:
a) in the case one of i) the network carrier has bandwidth of more than 5 MHz or ii) 2-symbol Physical Downlink Control Channel (PDCCH) is selected, the RRC configures different SSB indices 0 and 1 to adjacent sites;
b) in the case the network carrier has bandwidth of 5 MHz and 3-symbol PDCCH is selected, the RRC configures different SSB indices 1 and 3 to adjacent sites; and
c) in the case the network carrier has bandwidth of more than 5 MHz and 2-symbol PDCCH is chosen, the RRC configures different SSB indices to immediately adjacent sites such that no two adjacent sites have the same SSB index.

8. The system according to claim 1, wherein:
in the case of 2-sector cell sites, the RRC configures different SSB indices to the two sectors of each cell site.

9. The system according to claim 8, wherein at least one of:
a) in the case one of i) the network carrier has bandwidth of more than 5 MHz or ii) 2-symbol Physical Downlink Control Channel (PDCCH) is selected, the RRC configures different SSB indices 0 and 1 to the two sectors of each cell site; and
b) in the case the network carrier has bandwidth of 5 MHz and 3-symbol PDCCH is selected, the RRC configures different SSB indices 1 and 3 to the two sectors of each cell site.

10. The system according to claim 1, wherein:
in the case of 4-sector cell sites, the RRC configures different SSB indices of 0, 1, 2 and 3 to the four sectors of each cell site.

11. A method of optimizing signal to interference plus noise ratio (SINR) of a 5G New Radio (NR) network including multiple cell sites each having at least one sector, and at least one of the cell sites in communication with a user equipment (UE), the method comprising:
a radio resource controller (RRC) configured to control a combination synchronization signal and physical broadcast channel block (SSB) locations for all sectors of the cell sites; and
a medium access control (MAC) scheduler configured to schedule SSB in each sector in at least one of frequency and time;
wherein the RRC configures SSB indices for all sectors of the cell sites so that no two immediately adjacent sectors share the same SSB index.

12. The method according to claim 11, wherein:
the MAC scheduler selectively schedules physical downlink shared channel (PDSCH) in each sector in at least one of frequency and time, and
for an SSB index in a given resource block (RB) and a given symbol location for a given sector, the MAC scheduler does not schedule PDSCH for other sectors in the given RB and the given symbol location of the SSB index for the given sector.

13. The method according to claim 11, wherein:
in the case each cell site has 3 sectors, the RRC configures SSB indices 0, 1 and 3 to a first sector Alpha, a second sector Beta, and a third sector Gamma, respectively, of each cell site.

14. The method according to claim 11, wherein:
the RRC utilizes Physical Cell ID (PCI) modulo 3 (mod 3) operation to automatically configure each sector whereby i) each sector with PCI mod 3=0 is configured with SSB index 0, ii) each sector with PCI mod 3=1 is configured with SSB index 1; and iii) each sector with PCI mod 3=2 is configured with SSB index 3.

15. The method according to claim 11, wherein:
in the case of a network carrier with 5 MHz bandwidth, RRC configures 2 Orthogonal Frequency Division Multiplexing (OFDM) symbols for Physical Downlink Control Channel (PDCCH) in every ten slots starting at slot 0, and configures 3 OFDM symbols for PDCCH in other slots.

16. The method according to claim 11, wherein:
in the case of one of 1-sector or omni-directional cell sites, the RRC configures different SSB indices to the cell sites such that no two immediately adjacent cell sites have the same SSB index.

17. The method according to claim 16, wherein at least one of:
a) in the case one of i) the network carrier has bandwidth of more than 5 MHz or ii) 2-symbol Physical Downlink Control Channel (PDCCH) is selected, the RRC configures different SSB indices 0 and 1 to adjacent sites;
b) in the case the network carrier has bandwidth of 5 MHz and 3-symbol PDCCH is selected, the RRC configures different SSB indices 1 and 3 to adjacent sites; and
c) in the case the network carrier has bandwidth of more than 5 MHz and 2-symbol PDCCH is chosen, the RRC configures different SSB indices to immediately adjacent sites such that no two adjacent sites have the same SSB index.

18. The method according to claim 11, wherein:
in the case of 2-sector cell sites, the RRC configures different SSB indices to the two sectors of each cell site.

19. The method according to claim 18, wherein at least one of:
a) in the case one of i) the network carrier has bandwidth of more than 5 MHz or ii) 2-symbol Physical Downlink Control Channel (PDCCH) is selected, the RRC configures different SSB indices 0 and 1 to the two sectors of each cell site; and
b) in the case the network carrier has bandwidth of 5 MHz and 3-symbol PDCCH is selected, the RRC configures different SSB indices 1 and 3 to the two sectors of each cell site.

20. The method according to claim 11, wherein:
in the case of 4-sector cell sites, the RRC configures different SSB indices of 0, 1, 2 and 3 to the four sectors of each cell site.
